(19) United States
(12) Patent Application Publication
(10) Pub. No.: US 2025/0238990 A1
(43) Pub. Date: Jul. 24, 2025

(54) METHOD AND DEVICE OF GENERATING STICKER

(71) Applicant: Lemon, Inc., Grand Cayman (KY)

(72) Inventors: Weihong ZENG, Beijing (CN); Xu WANG, Beijing (CN); Jing LIU, Los Angeles, CA (US); Shen SANG, Los Angeles, CA (US); Haishan LIU, Beijing (CN)

(21) Appl. No.: 18/839,200

(22) PCT Filed: Feb. 6, 2023
(86) PCT No.: PCT/SG2023/050062

§ 371 Date: Aug. 16, 2024

(30) Foreign Application Priority Data
Feb. 16, 2022 (CN) 202210141281.7

(51) Int. Cl. G06T 13/40; G06T 7/20; G06T 7/70; G06T 17/00; G06V 10/25

(52) U.S. Cl. CPC G06T 13/40; G06T 7/20; G06T 7/70; G06T 17/00; G06V 10/25

(57) ABSTRACT

Embodiments of the disclosure provide a method and a device for generating a sticker. The method includes: obtaining material images of a plurality of components on an avatar; determining global positions of the components based on the material images; determining a target pose of the components under a target expression; and generating the sticker based on the material images, the global positions and the target pose; wherein in the sticker, an expression change of the avatar comprises a change from an initial expression to the target expression. Thus, the user only needs to input material images of a plurality of components on the avatar to generate a dynamic sticker of the avatar, thereby improving the production efficiency of the sticker and reducing the production difficulty of the sticker.

### CROSS REFERENCE TO RELATED APPLICATIONS

This application claims priority to Chinese Patent Application No. 202210141281.7, filed with the Chinese Patent Office on Feb. 16, 2022 and entitled ‘METHOD AND DEVICE OF GENERATING STICKER’, which is incorporated herein by reference in its entirety.

### FIELD

Embodiments of the present disclosure relate to the field of computer technologies, and in particular, to a method and device of generating a sticker.

### BACKGROUND

Stickers presented in a static image, a dynamic image, etc. are instinctive and interesting, and are highly favored by users. In addition to using a sticker in a chat, making a sticker becomes a favorite of some users.

Currently, a sticker needs to be drawn by a professional artist through a drawing tool. Especially for a dynamic sticker, a designer needs to design an avatar, design a motion, a gradient, motion alignment, and the like of the avatar, draw the avatar frame by frame, and finally play the sticker to form a dynamic sticker. The entire manufacturing process consumes much time and effort, and has a high requirement on the drawing skill.

Therefore, how to reduce the difficulty of making the sticker is a problem to be solved urgently at present.

### SUMMARY

Embodiments of the present disclosure provide a method and device of generating a sticker, so as to overcome the problem of relatively high difficult of the production of stickers.

According to a first aspect, an embodiment of the present disclosure provides a sticker generating method, comprising:
obtaining material images of a plurality of components on an avatar;
determining global positions of the components based on the material images;
determining a target pose of the components under a target expression; and
generating the sticker based on the material images, the global positions and the target pose;
wherein in the sticker, an expression change of the avatar comprises a change from an initial expression to the target expression.

According to a second aspect, an embodiment of the present disclosure provides a sticker generating apparatus, including:
an obtaining unit, configured to obtain material images of a plurality of components on an avatar;
a position determination unit, configured to determine global positions of the components based on the material images;
a pose determination unit, configured to determine a target pose of the components under a target expression; and
a generation unit, configured to generate the sticker based on the material images, the global positions and the target pose, wherein in the sticker, an expression change of the avatar comprises a change from an initial expression to the target expression.

According to a third aspect, an embodiment of the present disclosure provides an electronic device, including: at least one processor and a memory;
the memory storing a computer executive instruction;
the at least one processor executing a computer executive instruction stored by the memory, such that the at least one processor executes the method of generating a sticker according to the first aspect.

According to a fourth aspect, an embodiment of the present disclosure provides a computer readable storage medium. The computer readable storage medium stores a computer executive instruction. When a processor executes the computer executive instruction, the method of generating a sticker according to the first aspect is implemented.

According to a fifth aspect, a computer program product is provided according to one or more embodiments of the present disclosure. The computer program product comprises a computer executive instruction. When the processor executes the computer executive instruction, the method of generating a sticker according to the first aspect is implemented.

In a sixth aspect, according to one or more embodiments of the present disclosure, a computer program is provided. When a processor executes the computer program, the method of generating a sticker according to the first aspect is implemented.

Embodiments of the present disclosure provides are a method and device of generating a sticker. The method comprises: obtaining material images of a plurality of components on an avatar; determining global positions of the components based on the material images; determining a target pose of the components under a target expression; and generating the sticker based on the material images, the global positions and the target pose. Wherein an expression change of the avatar comprises a change from an initial expression to the target expression. Therefore, a user only needs to prepare material images of components on the avatar. The user does not need to design an expression of the avatar, and does not need to care about how to combine multiple frames of images, thereby effectively improving the production efficiency of a sticker and reducing production difficulties.

### BRIEF DESCRIPTION OF THE DRAWINGS

The accompanying drawings, which are incorporated herein and form part of the specification, illustrate embodiments consistent with the present disclosure and together with the description, and serve to explain the principles of the disclosure.

FIG. 1 is an exemplary diagram of an application scenario according to an embodiment of the present disclosure;

FIG. 2 is a first schematic flowchart illustrating a method for generating a sticker according to an embodiment of the present disclosure;

FIG. 3a is an exemplary illustration of material images of a plurality of components;

FIG. 3b is an example diagram of component categorization and component naming;

FIG. 4 is a second schematic flowchart of a sticker generating method according to an embodiment of the present disclosure;

FIG. 5 is a sticker of an animated avatar according to an embodiment of the present disclosure;

FIG. 6 is a structural block diagram of a model determination device according to an embodiment of the present disclosure;

FIG. 7 is a structural schematic diagram of a hardware structure of an electronic device according to an embodiment of the present disclosure.

### DETAILED DESCRIPTION

In order to make objects, technical solutions and advantages of the embodiments of the present disclosure more apparent, the technical solutions in the embodiments of the present disclosure will be described below in a clearly and fully understandable way in connection with the drawings related to the embodiments of the present disclosure. Obviously, the described embodiments are only a part but not all of the embodiments of the present disclosure. All other embodiments obtained by persons of ordinary skill in the art based on the embodiments of the present disclosure without creative efforts shall belong to the scope of protection of the present disclosure.

Firstly, the words involved in the disclosed embodiments are explained:
(1) Avatar: Virtual character depicted by images in a computing device, such as an anime character.
(2) A component of the avatar: a constituent part of the avatar; for example, the eyes, nose, mouth, etc. of the anime character all belong to a component of the anime character.
(3) A material image of a component: an image layer of the component is drawn, wherein different components may correspond to different material images, that is, different components may correspond to different image layers, thereby improving the flexibility of component assembly.
(4) Global position of a component: an image position of the component within an expression image in a sticker, wherein the expression image comprises an avatar obtained by combining a plurality of components.
(5) Pose of components: in a sticker, an expression of an avatar changes, and the change can be refined as a pose change of a component, for example, a change of an inclination degree and a bending degree of the component; therefore, the pose of the component may include the inclination degree, the bending degree, and the stretching degree of the component.

Secondly, a concept of an embodiment of the present disclosure is provided:

In the process of producing a dynamic sticker, a user usually needs to draw a plurality of frames of drawings by using a drawing tool, and then combine the drawn frames into a sticker. This process is time consuming and has high skill requirements.

In order to solve the described problem, the embodiments of the present disclosure provide a sticker generation method and device. In the embodiments of the present disclosure, material images of a plurality of components on an avatar are obtained, then positions and poses of the plurality of components are determined, and a corresponding dynamic sticker is generated on the basis of the material images, the positions and the poses of the plurality of components. In the whole process, the user only needs to prepare material images of a plurality of components on the avatar, without considering the drawing of each frame of a sticker, thereby effectively reducing the difficulty in making a sticker and improving the production efficiency.

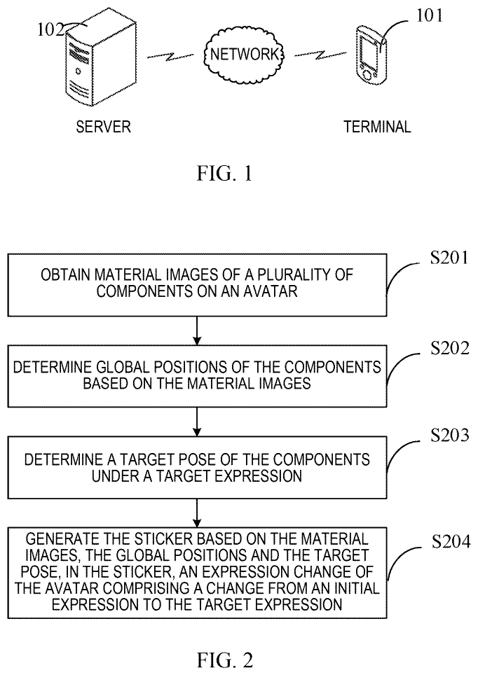

Referring to FIG. 1, FIG. 1 is an exemplary diagram of an application scenario according to an embodiment of the present disclosure.

As shown in FIG. 1, an application scenario is a dynamic sticker production scenario, in which a user may prepare material images of a plurality of components on an avatar on a terminal 101; and the terminal 101 generates a dynamic sticker on the basis of the material images of the plurality of components, or the terminal 101 may send the material images of the plurality of components to a server 102, and the server 102 generates a dynamic sticker on the basis of the material images of the plurality of components.

Exemplarily, in a chat scenario, a user wants to make a unique and interesting dynamic sticker, and may click on a sticker making page provided by a chat application program on a terminal. Material images of a plurality of components of an avatar such as a cartoon animal and an anime character designed by himself/herself may be input on the sticker making page. Alternatively, material images of a plurality of components of the avatar such as a cartoon animal and an anime character that are authorized to be available may also be input. The made sticker may be obtained through a sticker making program.

The following describes a sticker generating method and device provided in an embodiment of the present disclosure with reference to the application scenario shown in FIG. 1. It should be noted that the foregoing application scenarios are merely shown for facilitating understanding of the spirit and principle of the present disclosure, and the implementation of the present disclosure is not limited in this regard. Rather, embodiments of the present disclosure may be applied to any scenario where it is applicable.

It should be noted that the embodiments of the present disclosure may be applied to an electronic device, and the electronic device may be a terminal or a server. The terminal may be a personal digital assistant (PDA for short) device, a handheld device (such as a smartphone or a tablet computer) having a wireless communication function, a computing device (such as a personal computer, PC for short)), a vehicle-mounted device, a wearable device (such as a smart watch or a smart bracelet), a smart home device (such as a smart display device), and the like. The server may be an integral server or a decentralized server spanning multiple computers or computer data centers. The servers may also be of various categories, such as, but not limited to, web servers, application servers, or database servers, or proxy servers.

Referring to FIG. 2, FIG. 2 is a first flowchart illustrating a method for generating a sticker according to an embodiment of the present disclosure. As shown in FIG. 2, the method for generating a sticker includes:

S201. obtain material images of a plurality of components on an avatar.

In this embodiment, material images of a plurality of components input by a user may be obtained, where the plurality of components belong to a same avatar. For example, a user may input material images of a plurality of components through an input control of a sticker making page; for another example, the component material images of a plurality of avatars may be displayed on the sticker making page, and the user may select the material images of the plurality of components of the same avatar therefrom.

S202. determine global positions of the components based on the material images.

In this embodiment, the sizes of the material images corresponding to different components are consistent, and for each component, the position of the component in the material image is the global position of the component; therefore, the global position of the component may be obtained by determining the position of the component in the material image. Thus, the accuracy of the global position of the component in the expression graph is improved by means of the consistent size of the material images and the manner that the global position of the component in the expression image is determined by the position of the component in the material image.

In addition to the above manner, optionally, a global position of a component is randomly determined in a position range corresponding to the component, wherein different position ranges are set for different components in advance.

S203. determine a target pose of the components under a target expression.

The target expression includes one or more expressions, for example, happy, angry, sad, and the like.

In this embodiment, the target expression input by the user may be received, or a target expression selected by the user from one or more expressions may be obtained, or the target expression is determined to be a default expression. In motion poses corresponding to a plurality of components in one or more expressions, motion poses of the plurality of components under a target expression are determined. For ease of distinction, the motion poses of the plurality of components under the target expression are referred to as target pose of the plurality of components.

For example, obtaining an input text “happy” of a user, determining an expression of a target expression is “happy” according to the input text, and in motion poses of a plurality of components under the plurality of expressions, determining motion poses of components such as a head and a face under the target expression “happy”.

S204. generate the sticker based on the material images, the global positions and the target pose, wherein in the sticker, an expression change of the avatar comprises a change from an initial expression to the target expression.

Wherein, the initial expression refers to an expression in a sticker at an initial moment, that is, an expression represented by a first frame of image in the sticker or an image at a moment 0.

In this embodiment, the target pose of the component is the pose of the component under the target expression, and the expression of the avatar in the sticker changes from the initial expression to the target expression, which means that the pose of each component in the sticker changes gradually. Hence, after the global position and the target pose of the plurality of components are determined, for each component, the poses of the components at a plurality of moments may be determined based on the target pose of the component. Next, for each moment, the material images of the plurality of components are combined based on the global positions of the plurality of components and the poses of the plurality of components at this moment to obtain the sticker at this moment. In this manner, expression images at a plurality of moments are obtained, and a sticker is obtained by combining the expression images at a plurality of moments.

Optionally, the expression change of the avatar in the sticker further includes changing from the target expression to the initial expression, that is, the expression change of the avatar in the sticker changes from the initial expression to the target expression, and then changes from the target expression to the initial expression. For example, the avatar changes from not smiling to smiling, then changes from smiling to not smiling.

In the embodiments of the present disclosure, based on material images of a plurality of components on an avatar, global positions of components are determined; based on the global positions of the components and a target pose of components under a target expression, a sticker is obtained; and an expression image corresponding to the target expression may also be obtained. It can be seen that a user only needs to input material images of components to obtain a sticker with high quality, thereby effectively improving the production efficiency of the sticker and the expression image, reducing the production difficulty of the sticker and the expression image, and improving the user experience.

In the following, on the basis of the embodiment provided in FIG. 2, a plurality of feasible extension embodiments are provided.

### (1) Regarding the Avatar

In some embodiments, the avatar comprises an avatar of a character, especially an animated avatar of a character. Compared with other types of stickers, the sticker of the animated avatar of a character is difficult to produce, and 3D dynamic effects usually need to be drawn through a 2D image. In this embodiment, a user can obtain a dynamic sticker of an animated avatar of a character by inputting material images of a plurality of components on the animated avatar of a character. In addition, in the process of making the sticker, the positions and poses of various components are taken into consideration, so that not only the efficiency of making the dynamic sticker of the animated avatar of a character is improved, the production difficulty is reduced, but also the quality of the sticker is ensured.

### (2) Regarding Components

In some embodiments, essential components and non-essential components are preset.

Wherein, the essential components are necessary components for making the sticker of the avatar, and the non-essential components are optional components for making the sticker of the avatar. When the user inputs the material images of a plurality of components, the user must input the material images of all the essential components to ensure the integrity of the avatar in the sticker.

Here, a possible implementation of S201 includes: obtaining material images of a plurality of essential components on an avatar. Specifically, a user may be notified in advance about essential components of making a sticker, for example, names of the essential components are displayed on an expression making page, and for another example, whether the component is an essential component is marked around an input control corresponding to the component. The user must input material images of these essential components upon making a sticker.

Thus, by dividing the components into the essential components and the non-essential components, the success rate of making the sticker and the result of making the sticker are improved. Certainly, the user may also input the material image of the non-essential components after inputting the material images of the essential components, so as to further refine and enrich the avatar.

Alternatively, in response to the avatar being an animated avatar of a character, the essential component may include a eyebrows component, an upper eyelashes component, a pupil component, a mouth component and a face component. By means of these components, appearance of an animated avatar of a character may be accurately described, and a plurality of emotions may also be expressed vividly, thereby being beneficial for ensuring the integrity of an avatar and improving the vividness expression of the avatar.

Optionally, the non-essential components may include at least one of a following: a foreground component, a hair component, a head decorating component, a lower eyelashes component, white of the eyes component, a nose component, an ear component, a body component, and a background component. Thus, the avatar is made more detailed by these non-essential components.

Wherein the foreground component refers to a component located in front of the avatar according to the space relationship.

In some embodiments, a plurality of component categories are preset, and the plurality of component categories may be displayed before material images of the plurality of components on the avatar is obtained. Thus, it is convenient for a user to input a material image of a component according to a component category, wherein the component category may be divided into a plurality of hierarchical categories, and in response to the component categories being divided into two hierarchical categories, the component categories may be divided into a parent category and a child category under the parent category.

Optionally, the parent category includes at least one of the following: a foreground component, a hair component, a head component, a body component, and a background component. The child category under the hair component comprises at least one of a head decorating component, a front hair component, a front ear hair component, an rear ear hair component and a rear hair component; child category under the head component include the head decorating component, eyebrow component, eye component, nose component, mouth component, face component, ear component.

Further, the child categories may be further divided into different categories. Specifically, child categories under the eye component may include at least one of the following: an upper eyelash component, a lower eyelash component, a pupil component, and white of the eyes component.

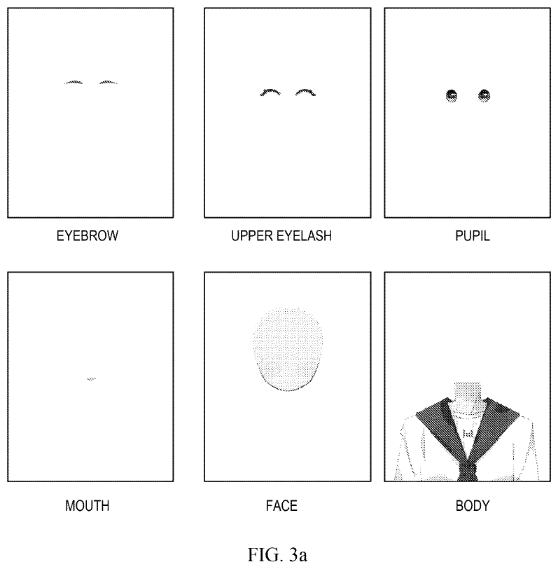

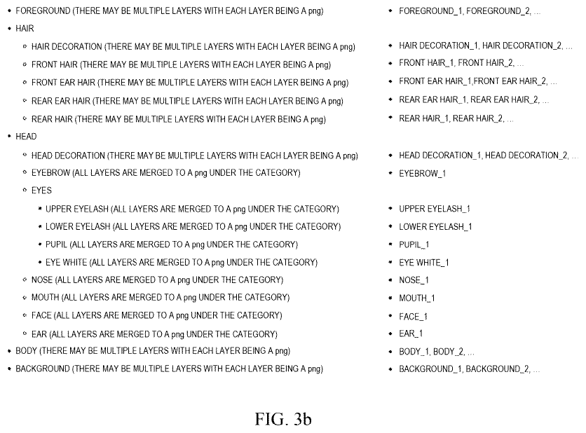

As an example, as shown in FIG. 3a, FIG. 3a is an example diagram of material images of a plurality of components. In FIG. 3a, material images respectively corresponding to an eyebrow component, an upper eyelash component, a pupil component, a mouth component, a face component and a body component of an animated avatar of a character are provided. It can be seen that these material images are consistent in size, and a corresponding animated avatar of a character may be obtained by combining and synthesizing the material images of these components.

### (3) Regarding the Material Images

In some embodiments, a component may correspond to one or more material images, e.g., the avatar has a plurality of head decorating components, so the head decorating components may correspond to a plurality of material images.

In some embodiments, a material image corresponds to a unique image identifier, that is, different material images correspond to different image identifiers. Thus, during the process of generating a sticker according to material images of components, the material image and a component corresponding to the material diagram may be distinguished by means of an image identifier.

Optionally, the image identifier includes an image name.

For example, image names of the plurality of material images corresponding to the foreground components are respectively foreground 1, foreground 2 . . . , and image names of the plurality of material images corresponding to the hair decorating component are respectively hair decorating component 1, hair decorating component 2 . . . , and so on.

As an example, as shown in FIG. 3b, FIG. 3b is an example diagram of component categories and component naming, in which a left-side area displays a plurality of components, and a right-side area displays a naming manner of a material image under a plurality of component types; a “layer” refers to the material image; and a “png” is an image format of the material image.

It can be seen from FIG. 3b that: 1) “foreground” may correspond to a plurality of layers of image, and the image may be named as foreground_1, foreground_2, etc.; 2) “hair decoration” may correspond to a plurality of layers of images, and image naming may be hair decoration_1, hair decoration_2, etc.; 3) “font hair” may correspond to a plurality of layers of images, and the image naming may be front hair_1, front hair_2, etc.; 4) “front ear hair” may correspond to a plurality of layers of images, and the image naming may be front ear hair_1, front ear hair_2, etc.; 5) “rear hair” may correspond to a plurality of layers of images, and the image naming can be rear hair_1, rear hair_2, etc.; 6) “head decoration” may correspond to a plurality of layers of images, and the image naming may be head decoration_1, head decoration_2, etc.; 7) “eyebrow” may correspond to a plurality of layers of images, and the plurality of layers of images may be combined into one png, that is, a plurality of material images may be combined into one material image, and the image naming may be eyebrow_1; . . . , etc. In this way, different naming can be provided for material images under different component categories, and different naming may be provided for different material images under the same component category. Details are not described herein one by one.

### (4) Regarding the Determination of Global Position

In some embodiments, a possible implementation of S202 comprises: in a material image of a component, determining bounding matrixes of the components; determining the global positions of the components based on the bounding matrixes of the components. Thus, by means of solving bounding matrixes of components, the accuracy of global positions of the components is improved.

In the present implementation, the bounding matrixes of the components may be identified in the material images of the components, so as to obtain the positions of the bounding matrixes of the components in the material images. The position of the bounding matrixes in the material images include coordinates of pixel points of four vertexes of the bounding matrixes in the material images. Then, since the sizes of the material images of all the components are consistent, and the image positions of the components in the material images reflect the global positions of the components, it may be determined that the global positions of the components are the positions of the bounding matrixes of the components.

Alternatively, the image channel of the material image of the component comprises a position channel.

Wherein, in the material image, a channel value of a pixel point in a position channel reflects whether the pixel point is located in a pattern area of a component. For example, if the channel value of the pixel in the position channel is 1, it is determined that the pixel is located in the pattern area; if the channel value of the pixel in the position channel is 0, it is determined that the pixel is not located in the pattern area. Hence, bounding matrixes of components in material images may be determined by means of the values of position channels of a plurality of pixel points in the material images, thereby improving the accuracy of the bounding matrixes.

Further, the material images of the components are an RGBA four-channel image, that is, the image channels of the material images of the components include an R channel, a G channel, a B channel, and an A channel. The R channel, the G channel, and the B channel are red, green, and blue color channels of an image, respectively, and the A channel is a position channel of the image.

Therefore, a channel value of each pixel point in an A channel may be acquired from a material image of a component, and a bounding matrix of the component is determined according to the channel value of the A channel of each pixel point. For example, all the pixel points with the channel value of channel A being 1 are determined, and a bounding matrix including these pixel points is determined as the bounding matrix of the component.

Further, the bounding matrix of the component may also be a minimum bounding rectangle (MBR) of the component, so as to improve the accuracy of the global position of the component.

### (5) Regarding the Determination of the Pose of the Component

In some embodiments, a possible implementation of S203 comprises: determining a sticker corresponding to a target expression according to a preset corresponding relationship between a plurality of expression types and expression motions, the expression motions corresponding to the target expressions including a target pose of a plurality of components under the target expression.

Wherein, the preset corresponding relationship between the plurality of expression types and the expression motions may be preset by a professional, so as to reduce the difficulty in making the sticker.

In the preset corresponding relationship, different expression types correspond to different expression motions, and the expression motions include motion poses of a plurality of preset components. Under different expression types, the preset components may be the same or different. For example, the expression type “smile” includes motion poses of the eyebrow component, the upper eyelash component, the pupil component, the mouth component and the face component, and the motion poses of the eyebrow component, the upper eyelash component and the mouth component may all be in a bending and lifting state; the expression “confusion” can further include expression symbol components (such as “question marks”) in addition to those in the described “smile” expression type, and the motion pose of the mouth component may be presented as straight or with the mouth being angled downwards.

In this implementation manner, a target expression type to which a target expression belongs may be determined from a plurality of expression types. Then, a preset corresponding relationship between a plurality of expression types and expression motions determines an expression motion corresponding to a target expression type, i.e. expression motions correspond to the target expression; and from the expression motion corresponding to the target expression, motion poses of a plurality of components on the avatar are found, i.e. target pose of the plurality of components are obtained.

In some embodiments, the motion poses of the components comprise the pose angles of the components, and the pose angles may comprise at least one of the following: a pitch angle, a yaw angle and a roll angle, so that the expression of the avatar in the sticker may be accurately represented by combining the positions of the components and the pose angles of the components.

When the motion poses of the components include the pose angles of the components, optionally, the initial expression is an expression when the pose angles of the components on the avatar is 0.

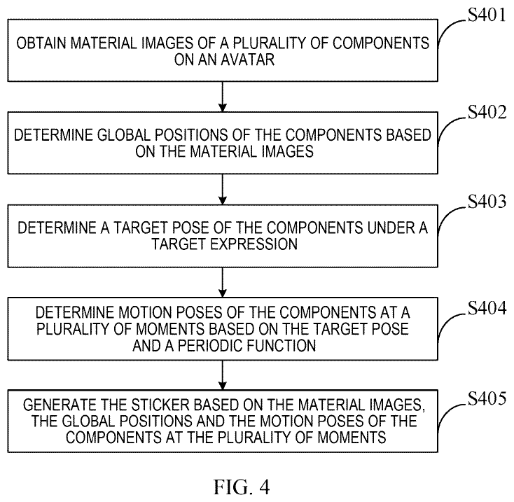

Referring to FIG. 4, FIG. 4 is a second flowchart illustrating a method for generating a sticker according to an embodiment of the present disclosure. As shown in FIG. 4, the sticker generation method comprises:

S401. obtaining material images of a plurality of components on an avatar.

S402. determining global positions of the components based on the material images.

S403. determining a target pose of the components under a target expression.

For implementation principles and technical effects of S401 to S403, reference may be made to the foregoing embodiments, and details are not described herein again.

S404. determining motion poses of the components at a plurality of moments based on the target pose and a periodic function.

For the motion postures of the components, reference may be made to the foregoing embodiments, and details are not described herein again.

In this embodiment, multiple frames of expression images in the sticker present stickers of the avatar at a plurality of moments, and the stickers at the plurality of moments include an initial expression and a target expression and further include a change of the expression between the initial expression and the target expression. Hence, in order to embody the expressions at the plurality of moments, it is necessary to determine the motion poses of the plurality of components at the plurality of moments respectively.

The process of changing the expression of the avatar in the sticker from the initial expression to the target expression is a process of gradually increasing the motion poses of the components to the target pose, and the process is slow and nonlinear. When the expression changing process of the avatar further includes a process of changing the expression from the target expression to the initial expression, the changing process is periodic. Therefore, in order to more accurately fit expression dynamic changing rule, the present embodiment uses a periodic function to determine the motion poses of components at a plurality of moments.

In this embodiment, the target pose is processed by the periodic function for each component to obtain the motion poses of the components at a plurality of moments within the period of the periodic function.

Wherein, if the expression changing process of the avatar in the sticker only comprises a process of changing the expression from an initial expression to a target expression, the target poses of the components are the motion poses of the components at the last moment; if the changing process of the avatar in the sticker includes a process of changing the expression from the initial expression to the target expression and then changing the expression from the target expression to the initial expression, the target poses of the components are the motion poses of the components at the intermediate moment.

In some embodiments, the different components use the same periodic function, so that the different components change their poses with a consistent amplitude at the same moment, and the pose changes of the different components in the sticker is more harmonic.

In some embodiments, one possible implementation of S404 comprises: determining expression weights of the components at a plurality of moments based on the periodic function; determining motion poses of the components at a plurality of moments based on the expression weights of the components at the plurality of moments and the target pose.

Wherein, the expression weight of the component at a moment reflects the amplitude of change of the motion pose of the component at the moment relative to the target pose of the component.

In this implementation, the expression weights of a component at a plurality of moments may be determined as function values of the periodic function at a plurality of moments. Then, for each moment, the expression weight of the component at that moment and the target pose of the component may be fused to obtain the motion pose of the component at that moment. Thus, by using a periodic function to determine the amplitude of change of the motion pose, the change of the motion pose of the component at a plurality of moments conforms to the expression change rule, thereby improving the accuracy of the dynamic expression in the sticker.

Optionally, fusion processing may be weighted computations, that is, for each moment, the expression weight of a component at the moment may be weighted with a target pose of the component at the moment, so as to obtain a motion pose of the component at the moment. Thus, expression weights may more reasonably affect motion poses of components at a plurality of moments, and motion pose changes of a component at a plurality of moments also more conform to an expression change rule.

Wherein, the calculation formula of the motion pose of the component a1 at the moment t may be expressed as: Vₐ₁^{t}=Vₐ₁*wight

wherein, Vₐ₁ is the target pose of the component a1, V^{t}ₐ₁ is the motion pose of the component a1 at the moment t, and weight is the expression weight at the moment t obtained based on the periodic function.

Further, when the motion pose includes pitch, yaw and roll, the calculation formula of the motion pose of the component a1 at the moment t may be expressed as:

$${V}_{a1 \_ pitch}^{t} = {V}_{a1 \_ pitch} * wight \\ {V}_{a1 \_ yaw}^{t} = {V}_{a1 \_ yaw} * wight \\ {V}_{a1 \_ roll}^{t} = {V}_{a1 \_ roll} * wight$$

wherein, V_{a1_pitch}, V_{a1_yaw}, V_{a1_roll} are respectively the pitch, yaw and roll angles in the target pose of the component a2, and V_{a1_pitch}^{t}, V_{a1_yaw}^{t}, V_{a1_roll}^{t} are respectively the pitch, yaw and roll angles in the motion pose of the component a2 at the moment r.

Optionally, in the process of determining the expression weights of the component at a plurality of moments according to the periodic function, the expression weights of the component at the plurality of moments may be determined according to the image frame number of the sticker and the frame rate of the sticker by using the periodic function. Thus, by combining the image frame number of a sticker and a frame rate in a periodic function, an expression weights corresponding to a component in each frame of an expression image in the sticker is determined more accurately, thereby improving the accuracy of motion poses of a component in each frame of the expression image.

In this optional manner, input data may be determined according to the image frame number of a sticker and a frame rate of the sticker, and the input data is input into a periodic function to obtain expression weights of a component at a plurality of moments.

Further, for each moment, the frame sequence of the expression image corresponding to the moment in the sticker may be determined; the ratio between the frame sequence of the expression image corresponding to the moment in the sticker and the frame rate of the sticker is determined as the input data corresponding to the moment; and the input data corresponding to the moment is input into the periodic function to obtain the expression weight of the component at the moment.

Optionally, the periodic function is determined according to the duration of the sticker, so as to improve the rationality and accuracy of the periodic function when the sticker is generated.

In this optional manner, the duration of the sticker may be determined as the period of the periodic function, or twice the duration of the sticker may be determined as the period of the periodic function, which is specifically determined according to a function value change range of the periodic function.

Optionally, the periodic function is a sine function. Because the function value change rule of the sine function is similar to the expression change rule, using the sine function to participate in the determination of the motion poses of the components at a plurality of moments may improve the accuracy and fluency of the motion poses of the components at the plurality of moments, thereby improving the accuracy and fluency of the expression of the avatar in the sticker.

When the periodic function is a sine function, a maximum function value of the sine function corresponds to the target expression, a process of changing the function value from 0 to the maximum function value is equivalent to a process of changing the expression of the avatar from the initial expression to the target expression, and a process of changing the function value from the maximum function value to 0 is equivalent to a process of changing the expression of the avatar from the target expression to the initial expression.

Further, when the periodic function is a sine function, the periodic function may be expressed as:

f(x)=sin(wx)

where, T=2π/|w|, Tis the period, x is the input of the sine function, and w is a parameter.

On the basis of the above formula, the expression weights of the component at a plurality of moments may be determined by combining the image frame number of the sticker and the frame rate of the sticker. At this situation, the periodic function may be expressed as:

$$weight = sin ( w \frac{1}{fps} )$$

where fps is the frame rate of the sticker, and i represents the i th frame image. Assuming that the i th frame image corresponds to the moment t, the expression weight of the component at the moment t may be obtained through the above formula.

Assuming that the duration of the sticker is 1 second, the expression of the avatar in the sticker changes from the initial moment to the target moment, and then changes from the target moment to the initial moment, the duration of the sticker is equivalent to a half period of the sine function, and therefore the period of the sine function is 2 seconds. At this point, the periodic function may be expressed as:

$$weight = sin ( 2 π \frac{i}{fps} )$$

S405. generate the sticker based on the material images, the global positions and the target pose.

For an implementation principle and a technical effect of S405, reference may be made to the foregoing embodiments, and details are not described herein again.

In the embodiments of the present disclosure, material images of a plurality of components on an avatar is obtained; global positions of components is determined according to the material images; a target pose of the components under a target expression is determined; motion poses of the components at a plurality of moments is determined according to the target pose and a periodic function; and a sticker is generated according to the global positions of the components and the motion poses of the components at the plurality of moments. Thus, the accuracy and fluency of motion states of a components at a plurality of moments are improved by using the feature that a function value change rule of a periodic function is close to an expression dynamic change rule, thereby improving the quality of a produced sticker.

### (6) Regarding Sticker Generation

In some embodiments, in the process of generating a sticker according to material images of components, global positions of the components and motion poses of the components at a plurality of moments, a possible implementation comprises: according to the global positions and the motion poses of the components at the plurality of moments, determining a position and a shape of the material image on each frame of image in the sticker by means of a driving algorithm, so as to obtain the sticker.

In this embodiment, a driving algorithm is used for driving a material image, and specifically, is used for driving the material images of a components to corresponding positions and corresponding shapes according to global positions of the components and a motion poses of the components, so that the driven material images form an expression image in a sticker.

Optionally, in a driving algorithm, for each component, a component image may be obtained from a material image of the component, and the component image is divided into a plurality of rectangular image areas, and vertices of each image area are obtained, and depth values of each vertices are determined, so that the component image visually presents a three-dimensional effect, such that an avatar in a sticker is more stereo, thereby improving a sticker generation effect.

Depth values corresponding to different components may be preset, and a front-rear position relationship of material images may also be determined based on an image identifier (such as an image name) of the material image, so as to determine a corresponding depth value.

Optionally, in a driving algorithm, facial feature information may be determined according to global positions of a plurality of components; rotation matrixes of each material image are determined according to motion poses of the plurality of components at a plurality of moments; and displacement transformation and rotation are performed on the material images according to the facial feature information and the rotation matrixes of the material images.

The facial feature information related to the plurality of key points may be determined based on global positions of the plurality of key points (such as eyebrows, eyes, pupils, and mouth) on the material images of the components, so as to improve the stability of the facial feature information, thereby improving the stability of the expression. The facial feature information may be, for example, a moving height of left/right eyebrows, an opening height of left/right eyes, an opening size of a mouth, and a width of the mouth.

In this optional manner, after the facial feature information related to the plurality of key points is obtained, the maximum deformation values of the plurality of key points may be determined based on the facial feature information. The maximum deformation value of the key point of the face may include an upper limit value and a lower limit value of the motion of the key points. For example, the upper limit value of the eyes is a feature value when the eyes are open, and the lower limit value is a feature value when the eyes are closed.

In this optional manner, for each key point, a feature value corresponding to a change of the key point (for example, blinking up and down eyes) may be determined in facial feature information of the key points, determining the deformation values of the key points according to the corresponding feature values when the key point changes and the maximum deformation value corresponding to the key points, that is, the displacement value of the key points. And according to the displacement values of the key points, the position change of the key points is driven and drawn and rendered, such that the deformation of the key points is realized. And rotating the material images according to the rotation matrixes of the material images, so as to complete the driving of the material images of the components and realize the automatic generation of the sticker.

Optionally, during the driving process, considering that a blank or a gap will be generated when the component is deformed, the morphology may be used to fill the image, so as to improve the effect of sticker generation. For example, an image of the upper and lower eyelids and an image of the oral cavity are automatically generated by using morphology.

According to the foregoing embodiments, a sticker may be obtained, and each frame of the expression image of an avatar in the sticker may also be obtained. In particular, a stop-motion sticker of the avatar may be obtained, that is, the expression of the avatar is an expression image of a target expression. Because the expression of the avatar in the sticker changes from the initial expression to the target expression and then changes from the target expression to the initial expression, the stop-motion expression image is an expression image with the maximum amplitude of the expression of the avatar in the sticker. Thus, the production efficiency of a dynamic sticker and a static stop-motion expression image is improved, the production difficulty is reduced, and the production experience of a sticker of a user is improved.

Taking the target expression ‘smile’ as an example, the expression of the avatar in the sticker changes from ‘not smiling’ to ‘smiling’ and then changes from ‘smiling’ to ‘not smiling’, and the expression image of” smiling’ of the avatar may be obtained from the expression image.

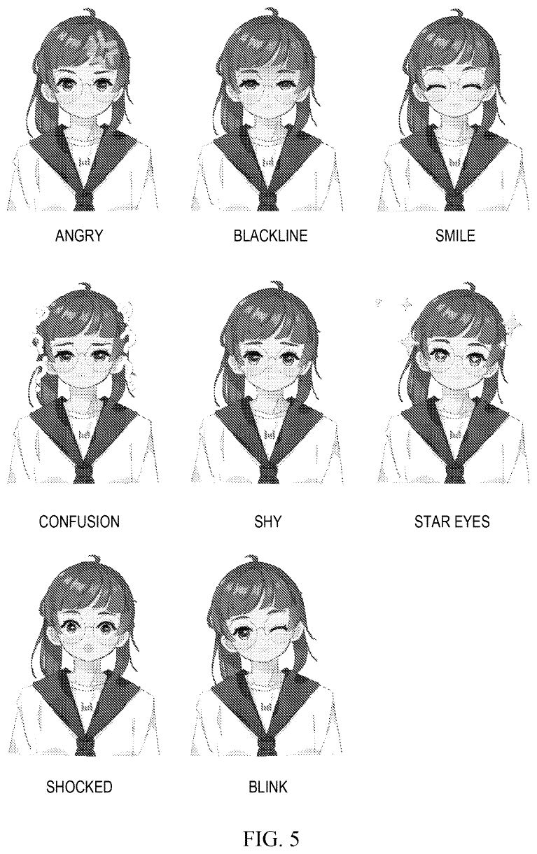

By way of example, FIG. 5 presents expression images of an animated avatar of a character without an expression (namely, an expression image under an initial expression) and stop-motion expression images of an animated avatar of a character under a plurality of target expressions of “angry”, “black line”, “smile”, “confusion”, “shy”, “shock”, “blink”. Based on the sticker generation method provided in any embodiment of the present disclosure, stickers of animated avatar of a character in these target expressions may be generated, for example, stickers from no expression to anger and from anger to no expression.

In FIG. 5, in addition to facial features of an animated avatar, a pair of glasses of the animated avatar of a character and expression symbols on the animated avatar of a character (e.g. an angry symbol in a stop-motion expression image corresponding to “angry”, e.g. question marks in a stop-motion expression image corresponding to “confusion”, e.g. stars in a stop-motion expression image corresponding to “blink”) also belong to components on the animated avatar of a character, and the positions and poses may also be determined by the described embodiments.

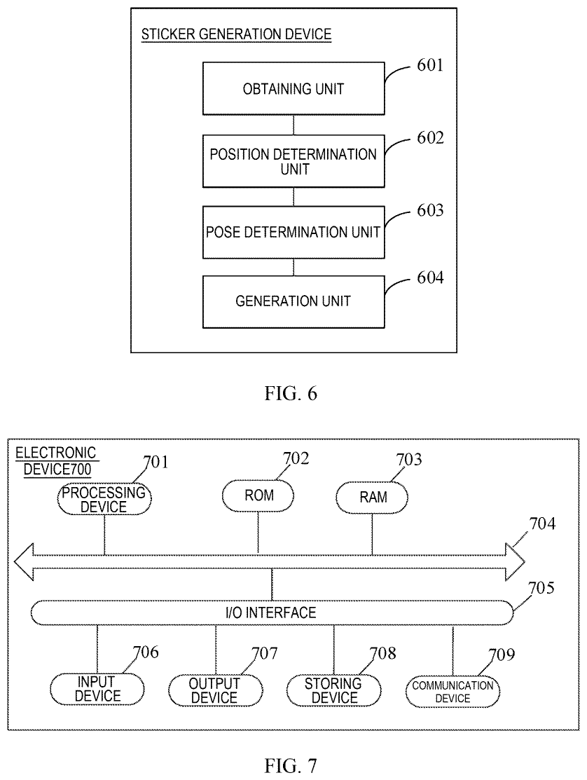

Corresponding to the sticker generating method in the foregoing embodiments, FIG. 6 is a block diagram of a sticker generating device according to an embodiment of the present disclosure. For ease of description, only components related to the embodiments of the present disclosure are shown. Referring to FIG. 6, the sticker generating device includes: an obtaining unit 601, a position determination unit 602, a pose determination unit 603, and a generation unit 604.

An obtaining unit 601, configured to obtain material images of a plurality of components on an avatar;
a position determination unit 602, configured to determine global positions of the components based on the material images;
a pose determination unit 603, configured to determine a target pose of the components under a target expression;
a generation unit 604, configured to generate the sticker based on the material images, the global positions and the target pose, wherein in the sticker, an expression change of the avatar comprises a change from an initial expression to the target expression.

In some embodiments, in the process of generating the sticker based on the material image, the global position, and the target pose, the generation unit 604 is specifically used for: determining motion poses of the components at a plurality of moments based on the target pose and a periodic function; generating the sticker based on the material images, the global positions and the motion poses of the components at the plurality of moments, wherein an expression of the avatar in the sticker at an initial moment in the plurality of moments is the initial expression.

In some embodiments, in the process of determining the motion poses of the components at the plurality of moments based on the target pose and the periodic function, the generation unit 604 is specifically used for: determining expression weights of the components at a plurality of moments based on the periodic function; determining motion poses of the components at a plurality of moments based on the expression weights of the components at the plurality of moments and the target pose.

In some embodiments, in the process of determining the expression weights of the components at the plurality of moments based on the periodic function, the generation unit 604 is specifically configured for: determining, through the periodic function, the expression weights of the components at the plurality of moments based on the number of frames of the sticker and a frame rate of the sticker.

In some embodiments, the sticker generating device further comprises: a function determination unit (not shown in the figure), configured to determine the periodic function based on a duration of the sticker; wherein the periodic function is a sinusoidal function.

In some embodiments, in the process of generating the sticker based on the material images, the global positions, and motion poses of the components at a plurality of moments, the generation unit 604 is specifically configured to: determine, through a driving algorithm, a position and a shape of the material image on each frame of image in the sticker based on the global positions and motion poses of the components at the plurality of moments to obtain the sticker.

In some embodiments, in the process of determining the target pose of the components under the target expression, the pose determination unit 603 is specifically used for: determining an expression motion corresponding to the target expression based on a predetermined corresponding relationship between a plurality of expression types and expression motions, the expression motion corresponding to the target expression comprising the target pose.

In some embodiments, determining the global positions of the components based on the material images, the position determination unit 602 is specifically used for: determining bounding matrixes of the components in the material images; determining the global positions based on the bounding matrixes.

The sticker generating device provided in this embodiment may be used to execute the technical solution of the embodiment of the sticker generating method. The implementation principle and technical effect are similar, and are not repeatedly described herein in this embodiment.

Referring to FIG. 7, a schematic structural diagram of an electronic device 700 suitable for implementing an embodiment of the present disclosure is shown. The electronic device 700 may be a terminal device or a server. The terminal device may include, but is not limited to, a mobile terminal such as a mobile phone, a laptop computer, a digital broadcast receiver, a personal digital assistant (Personal Digital Assistant, PDA for short), a tablet computer (Portable Android Device, PAD for short), a portable multimedia player (Portable Media Player, PMP for short), a vehicle-mounted terminal (for example, a vehicle-mounted navigation terminal), and the like, and a fixed terminal such as a digital TV, a desktop computer, and the like. The electronic device shown in FIG. 7 is merely an example and should not bring any limitation to the functions and scope of use of embodiments of the present disclosure.

As shown in FIG. 7, the electronic device 700 may include a processing device (e.g., central processing unit, graphics processor, etc.) 701 that may perform various suitable actions and processes in accordance with a program stored in a read only memory (ROM) 702 or a program loaded into a random-access memory (RAM) 703 from a storage device 708. A variety of programs and data necessary for the operation of the electronic device 700 are also stored in the RAM 703. The processing apparatus 701, the ROM 702, and the RAM 703 are connected to each other via the bus 704. An input/output (Input/Output, I/O) interface 705 is also connected to the bus 704.

In general, the following devices may be connected to the I/O interface 705: an input device 706 including, for example, a touch screen, a touch pad, a keyboard, a mouse, a camera, a microphone, an accelerometer, a gyroscope, or the like; an output device 707 including, for example, a liquid crystal display (LCD), a speaker, a vibrator, or the like; a storage device 708 including, for example, a magnetic tape, a hard disk, or the like; and a communication device 709. Communication device 709 can allow electronic device 700 to communicate wirelessly or wired with other devices to exchange data. While FIG. 7 illustrates an electronic device 700 having various means, it is to be understood that not all of the illustrated means are required to be implemented or provided. More or fewer devices may alternatively be implemented or provided.

In particular, the processes described above with reference to the flowcharts can be implemented as computer software programs in accordance with embodiments of the present disclosure. For example, embodiments of the present disclosure include a computer program product comprising a computer program carried on a computer readable medium. The computer program comprises a program code for executing the method as shown in the flowchart. In such an embodiment, the computer program may be downloaded and installed from the network through the communication device 709, installed from the storage device 708, or installed from the ROM 702. When the computer program is executed by the processing apparatus 701, the described functions defined in the method according to the embodiment of the present disclosure are executed.

It should be noted that the computer readable medium in the present disclosure may be a computer readable signal medium or a computer readable storage medium, or any combination thereof. A computer-readable storage medium may be, for example, but not limited to, an electronic, magnetic, optical, electromagnetic, infrared, or semiconductor system, apparatus, or device, or any suitable combination of the foregoing. More specific examples of the computer readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain or store a program for use by or in connection with an instruction execution system, apparatus, or device. While in the present disclosure, a computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may also be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including, but not limited to, wireline, optical fiber cable, RF (Radio Frequency), etc., or any suitable combination of the foregoing.

The computer readable medium may be included in the electronic device, or may exist separately and not be installed in the electronic device.

The computer readable medium bears one or more programs, and when the one or more programs are executed by the electronic device, the electronic device is enabled to execute the method shown in the foregoing embodiments.

Computer program code for carrying out operations for aspects of the present disclosure may be written in any combination of one or more programming languages, including an object-oriented programming language such as Java, Smalltalk, C++ or the like and conventional procedural programming languages, such as the ‘C’ programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The units involved in the embodiments of the present disclosure may be implemented through software or hardware. The name of a unit does not constitute a limitation to the unit itself in some cases, for example, the first acquisition unit may also be described as “unit to acquire at least two internet protocol addresses”.

The functions described herein above may be performed, at least in part, by one or more hardware logic components. For example, exemplary types of hardware logic components that can be used include, without limitation, Field Programmable Gate Arrays (FPGAs), Application Specific Integrated Circuit (ASICs), Application Specific Standard Products (ASSPs), System on Chip (SOCs), Complex Programmable Logic Devices (CPLDs), etc.

In the context of this disclosure, a machine-readable medium may be tangible media that may contain or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media would include an electrical connection based on one or more wires, a portable computer diskette, a hard disk, a random-access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing.

According to a first aspect, according to one or more embodiments of the present disclosure, provided is a method of generating a sticker, comprising: obtaining material images of a plurality of components on an avatar; determining global positions of the components based on the material images; determining a target pose of the components under a target expression; generating the sticker based on the material images, the global positions and the target pose, wherein in the sticker, an expression change of the avatar comprises a change from an initial expression to the target expression.

According to one or more embodiments of the present disclosure, generating the sticker based on the material image, the global position, and the target pose comprises: determining motion poses of the components at a plurality of moments based on the target pose and a periodic function; and generating the sticker based on the material images, the global positions and the motion poses of the components at the plurality of moments, wherein an expression of the avatar in the sticker at an initial moment in the plurality of moments is the initial expression.

According to one or more embodiments of the present disclosure, the determining the motion poses of the components at the plurality of moments based on the target pose and the periodic function comprises: determining expression weights of the components at a plurality of moments based on the periodic function; and determining motion poses of the components at a plurality of moments based on the expression weights of the components at the plurality of moments and the target pose.

According to one or more embodiments of the present disclosure, the determining the expression weights of the components at the plurality of moments based on the periodic function comprises: determining, through the periodic function, the expression weights of the components at the plurality of moments based on the number of frames of the sticker and a frame rate of the sticker.

According to one or more embodiments of the present disclosure, before determining the motion poses of the components at the plurality of moments based on the target pose and the periodic function further comprises: determining the periodic function based on a duration of the sticker; wherein the periodic function is a sinusoidal function.

According to one or more embodiments of the present disclosure, the generating the sticker based on the material images, the global positions, and motion poses of the components at a plurality of moments comprises: determining, through a driving algorithm, a position and a shape of the material image on each frame of image in the sticker based on the global positions and motion poses of the components at the plurality of moments to obtain the sticker.

According to one or more embodiments of the present disclosure, the determining the target pose of the components under the target expression comprises: determining an expression motion corresponding to the target expression based on a predetermined corresponding relationship between a plurality of expression types and expression motions, the expression motion corresponding to the target expression comprising the target pose.

According to one or more embodiments of the present disclosure, the determining the global positions of the components based on the material images comprises: determining bounding matrixes of the components in the material images; and determining the global positions based on the bounding matrixes.

According to a second aspect, according to one or more embodiments of the present disclosure, provided is a device for generating a sticker, comprising: an obtaining unit, configured to obtain material images of a plurality of components on an avatar; a position determination unit, configured to determine global positions of the components based on the material images; a pose determination unit, configured to determine a target pose of the components under a target expression; and a generation unit, configured to generate the sticker based on the material images, the global positions and the target pose, wherein in the sticker, an expression change of the avatar comprises a change from an initial expression to the target expression.

According to one or more embodiments of the present disclosure, in the process of generating the sticker based on the material image, the global position, and the target pose, the generation unit is specifically used for: determining motion poses of the components at a plurality of moments based on the target pose and a periodic function; and generating the sticker based on the material images, the global positions and the motion poses of the components at the plurality of moments, wherein an expression of the avatar in the sticker at an initial moment in the plurality of moments is the initial expression.

According to one or more embodiments of the present disclosure, in the process of determining the motion poses of the components at the plurality of moments based on the target pose and the periodic function comprises, the generation unit is specifically configured to: determine expression weights of the components at a plurality of moments based on the periodic function; and determine motion poses of the components at a plurality of moments based on the expression weights of the components at the plurality of moments and the target pose.

According to one or more embodiments of the present disclosure, in the process of determining the expression weights of the components at the plurality of moments based on the periodic function, the generation unit is specifically configured to: determine, through the periodic function, the expression weights of the components at the plurality of moments based on the number of frames of the sticker and a frame rate of the sticker.

According to one or more embodiments of the present disclosure, the device for generating a sticker further comprises: a function determination unit, configured to determine the periodic function based on a duration of the sticker; wherein the periodic function is a sinusoidal function.

According to one or more embodiments of the present disclosure, in the process of generating the sticker based on the material images, the global positions, and motion poses of the components at a plurality of moments, the generation unit is specifically used for: determining, through a driving algorithm, a position and a shape of the material image on each frame of image in the sticker based on the global positions and motion poses of the components at the plurality of moments to obtain the sticker.

According to one or more embodiments of the present disclosure, in the process of determining the target pose of the components under the target expression, the pose determination unit is specifically configured to: determine an expression motion corresponding to the target expression based on a predetermined corresponding relationship between a plurality of expression types and expression motions, the expression motion corresponding to the target expression comprising the target pose.

According to one or more embodiments of the present disclosure, in the process of determining the global positions of the components based on the material images, the position determination unit is specifically configured to: determine bounding matrixes of the components in the material images; and determine the global positions based on the bounding matrixes.

According to a third aspect, according to one or more embodiments of the present disclosure, there is provided an electronic device, comprising: at least one processor and a memory; The memory stores a computer execution instruction; and the at least one processor executes the computer execution instruction stored in the memory, so that the at least one processor executes the method of generating a sticker according to the first aspect or various possible designs according to the first aspect, or executes the model training method according to the second aspect or various possible designs according to the second aspect.

According to a fourth aspect, a computer readable storage medium is provided according to one or more embodiments of the present disclosure. The computer readable storage medium stores a computer executive instruction. When a processor executes the computer executive instruction, the sticker generation method according to the first aspect and various possible designs of the first aspect is implemented.

According to a fifth aspect, a computer program product is provided according to one or more embodiments of the present disclosure. The computer program product includes a computer executive instruction. When a processor executes the computer executive instruction, a method for generating a sticker according to various possible designs of the first aspect and the first aspect is implemented.

In a sixth aspect, according to one or more embodiments of the present disclosure, a computer program is provided, and when a processor executes the computer program, the sticker generation method according to various possible designs of the first aspect and the first aspect is implemented.

The foregoing description is merely illustrative of the preferred embodiments of the present disclosure and of the technical principles applied thereto, as will be appreciated by those skilled in the art, The disclosure of the present disclosure is not limited to the technical solution formed by the specific combination of the described technical features, At the same time, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution.

In addition, while operations are depicted in a particular order, this should not be understood as requiring that the operations be performed in the particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1. A method of generating a sticker, comprising:
obtaining material images of a plurality of components on an avatar;
determining global positions of the components based on the material images;
determining a target pose of the components under a target expression; and
generating the sticker based on the material images, the global positions and the target pose;
wherein the sticker comprises a changing expression of the avatar from an initial expression to the target expression.

2. The method of generating a sticker of claim 1, wherein generating the sticker based on the material image, the global position, and the target pose comprises:
determining motion poses of the components at a plurality of moments based on the target pose and a periodic function; and
generating the sticker based on the material images, the global positions and the motion poses of the components at the plurality of moments, wherein an expression of the avatar in the sticker at an initial moment in the plurality of moments is the initial expression.

3. The method of generating a sticker of claim 2, wherein determining the motion poses of the components at the plurality of moments based on the target pose and the periodic function comprises:
determining expression weights of the components at a plurality of moments based on the periodic function; and
determining motion poses of the components at a plurality of moments based on the expression weights of the components at the plurality of moments and the target pose.

4. The method of generating a sticker of claim 3, wherein determining the expression weights of the components at the plurality of moments based on the periodic function comprises:
determining, through the periodic function, the expression weights of the components at the plurality of moments based on the number of frames of the sticker and a frame rate of the sticker.

5. The method of generating a sticker of claim 2, wherein before determining the motion poses of the components at the plurality of moments based on the target pose and the periodic function further comprises:
determining the periodic function based on a duration of the sticker;
wherein the periodic function is a sinusoidal function.

6. The method of generating a sticker of claim 2, wherein generating the sticker based on the material images, the global positions, and motion poses of the components at a plurality of moments comprises:
determining, through a driving algorithm, a position and a shape of the material image on each frame of image in the sticker based on the global positions and motion poses of the components at the plurality of moments to obtain the sticker.

7. The method of generating a sticker of claim 2, wherein determining the target pose of the components under the target expression comprises:
determining an expression motion corresponding to the target expression based on a predetermined corresponding relationship between a plurality of expression types and expression motions, the expression motion corresponding to the target expression comprising the target pose.

8. The method of generating a sticker of claim 1, wherein determining the global positions of the components based on the material images comprises:
determining bounding matrixes of the components in the material images; and
determining the global positions based on the bounding matrixes.

9. (canceled)

10. An electronic device, comprising:
at least one processor and memory;
the memory storing a computer executive instruction;
the at least one processor executing a computer executive instruction stored by the memory, such that the at least one processor executes the method of generating a sticker of comprising:
obtaining material images of a plurality of components on an avatar;
determining global positions of the components based on the material images;
determining a target pose of the components under a target expression; and
generating the sticker based on the material images, the global positions and the target pose;
wherein the sticker comprises a changing expression of the avatar from an initial expression to the target expression.

11. A non-transitory computer readable storage medium, the computer readable storage medium storing a computer executive instruction therein, wherein, in response to a processor executing the computer executive instruction, the processor implements the method of generating a sticker comprising:
obtaining material images of a plurality of components on an avatar;
determining global positions of the components based on the material images;
determining a target pose of the components under a target expression; and
generating the sticker based on the material images, the global positions and the target pose;
wherein the sticker comprises a changing expression of the avatar from an initial expression to the target expression.

12. (canceled)

13. (canceled)

14. The non-transitory computer readable storage medium of claim 11, wherein generating the sticker based on the material image, the global position, and the target pose comprises:
determining motion poses of the components at a plurality of moments based on the target pose and a periodic function; and
generating the sticker based on the material images, the global positions and the motion poses of the components at the plurality of moments, wherein an expression of the avatar in the sticker at an initial moment in the plurality of moments is the initial expression.

15. The non-transitory computer readable storage medium of claim 14, wherein determining the motion poses of the components at the plurality of moments based on the target pose and the periodic function comprises:
determining expression weights of the components at a plurality of moments based on the periodic function; and
determining motion poses of the components at a plurality of moments based on the expression weights of the components at the plurality of moments and the target pose.

16. The non-transitory computer readable storage medium of claim 15, wherein determining the expression weights of the components at the plurality of moments based on the periodic function comprises:
determining, through the periodic function, the expression weights of the components at the plurality of moments based on the number of frames of the sticker and a frame rate of the sticker.

17. The electronic device of claim 10, wherein generating the sticker based on the material image, the global position, and the target pose comprises:
determining motion poses of the components at a plurality of moments based on the target pose and a periodic function; and
generating the sticker based on the material images, the global positions and the motion poses of the components at the plurality of moments, wherein an expression of the avatar in the sticker at an initial moment in the plurality of moments is the initial expression.

18. The electronic device of claim 17, wherein determining the motion poses of the components at the plurality of moments based on the target pose and the periodic function comprises:
determining expression weights of the components at a plurality of moments based on the periodic function; and
determining motion poses of the components at a plurality of moments based on the expression weights of the components at the plurality of moments and the target pose.

19. The electronic device of claim 18, wherein determining the expression weights of the components at the plurality of moments based on the periodic function comprises:
determining, through the periodic function, the expression weights of the components at the plurality of moments based on the number of frames of the sticker and a frame rate of the sticker.

20. The electronic device of claim 17, wherein before determining the motion poses of the components at the plurality of moments based on the target pose and the periodic function further comprises:
determining the periodic function based on a duration of the sticker;
wherein the periodic function is a sinusoidal function.

21. The electronic device of claim 17, wherein generating the sticker based on the material images, the global positions, and motion poses of the components at a plurality of moments comprises:
determining, through a driving algorithm, a position and a shape of the material image on each frame of image in the sticker based on the global positions and motion poses of the components at the plurality of moments to obtain the sticker.

22. The electronic device of claim 10, wherein determining the target pose of the components under the target expression comprises:
determining an expression motion corresponding to the target expression based on a predetermined corresponding relationship between a plurality of expression types and expression motions, the expression motion corresponding to the target expression comprising the target pose.

23. The electronic device of claim 10, wherein determining the global positions of the components based on the material images comprises:
determining bounding matrixes of the components in the material images; and
determining the global positions based on the bounding matrixes.
